(19) United States
(12) Patent Application Publication
(10) Pub. No.: US 2005/0180392 A1
(43) Pub. Date: Aug. 18, 2005

(54) Device for automatically extending text messages, and methods therefor

(76) Inventor: Andrew Watkins, West Midlands (GB)

Correspondence Address: WELLS ST. JOHN P.S., 601 W. FIRST AVENUE, SUITE 1300, SPOKANE, WA, 99201, US

(21) Appl. No.: 10/483,273

(22) PCT Filed: Jul. 9, 2002
(86) PCT No.: PCT/GB02/03082

(30) Foreign Application Priority Data
Jul. 11, 2001 (GB) 0116964.8

(51) Int. Cl. H04L 12/66

(52) U.S. Cl. 370/352

(57) ABSTRACT

A communications device operable to electronically process data for representing characters of a text message is described. At least some or all of the characters are encodable as data using a plurality of character codes which require respective computer memory units of mutually different sizes to respectively store sufficient data to represent a single character. The device comprises memory means operable to receive and store text character information relating to desired characters input by a user. Determining means is provided operable to determine which of the character codes is appropriate for representing the desired characters. Means is provided operable to automatically place the device in an operating mode which enables use of the appropriate character code which requires the smallest computer memory unit per character for storing the encoded character information for transmission over a network.

The invention relates to communications devices operable to electronically process text data for representing characters of a text message, and to methods for operating such devices. The invention also relates to computer programs comprising computer executable instructions for causing a computer to perform any one of the methods, and to carriers having stored thereon such programs.

A text message may comprise text characters of varying complexity. The more complex characters may be representable only according to a relatively complex character code specifically adapted therefor. Such relatively complex codes will generally require a larger unit of computer memory to store sufficient data to represent a single character than a less complex code. Less complex characters will generally be representable in accordance with a plurality of codes of varying complexity. An example of a more complex code is Unicode, which can be employed to represent complex characters such as Chinese characters, in addition to less complex characters such as Western alphanumeric characters. However, Unicode requires two bytes of computer memory per character, whereas a less complex code such as the GSM short message service (SMS) employs only seven bits per character.

Communications devices are known with alternative settings which selectively enable operation in alternative operating modes which respectively use more complex and less complex character codes for encoding text message information as data for transmission over a network. The particular operating mode in use at any given time will be the device's default setting or an alternative setting preselected by the user. The selection operation is not automatic, that is, if a user wishes to send messages containing more complex characters, such devices must be pre-set to operate using a more complex character code before message information is input for processing. Also, the entire message must be encoded and decoded in the pre-set operating mode.

Furthermore, message communication services generally specify a threshold message size, limiting the amount of text data which can be sent in a single transmission over their network(s). Messages which are larger than the threshold size cannot be transmitted in their entirety as a single message. The specified threshold size may vary according to the network employed by the communication service(s) in the geographic area(s) through which it is necessary to route the message.

To overcome this problem, whilst minimising inconvenience to a user who wishes to send a longer message, U.S. Pat. No. 5,708,781 discloses a method for dividedly transmitting and receiving message data in a plurality of message packets, when an amount of message data to be transmitted exceeds an amount of data allowed in a data communications system. Also, WO-A1-01/22750 discloses a method of constructing a composite message from multiple SMS messages in a wireless communications system. These documents disclose arrangements for ensuring a larger message is reconstituted in the correct order of its constituent smaller message portions when these portions are concatenated in a receiving communications device.

In known communications devices, when sending a large text message which contains a mixture of complex and less complex characters, the device must be pre-set in an operating mode which enables all of the characters in the message to be encoded using a more complex character code. This increases the memory requirement per character, even for the less complex characters, and reduces the number of characters which can be contained in each short message portion when the message is divided for sending.

In accordance with the invention, there is provided a method of operating a communications device operable to electronically process data for representing characters of a text message, at least some or all of the characters being definable using a plurality of character codes which require respective computer memory units of mutually different sizes to respectively store sufficient data to represent a single character, the method comprising:
causing the device to receive text character information relating to desired characters input by a user;
causing the device to determine which of the character codes is appropriate for representing the desired characters; and
automatically placing the device in an operating mode which enables use of the appropriate character code which requires the smallest computer memory unit per character for storing the encoded character information transmission over a network.

In accordance with a further aspect of the invention, there is provided a communications device operable to electronically process data for representing characters of a text message, at least some or all of the characters being encodable as data using a plurality of character codes which require respective computer memory units of mutually different sizes to respectively store sufficient data to represent a single character, the device comprising:
memory means operable to receive and store text character information relating to desired characters input by a user;
determining means operable to determine which of the character codes is appropriate for representing the desired characters; and
means operable to automatically place the device in an operating mode which enables use of the appropriate character code which requires the smallest computer memory unit per character for storing the encoded character information for transmission over a network.

In accordance with a further aspect of the invention, there is provided a method of operating a communications device so as to receive and enable display of character information which has been processed according to the method described above, comprising:
causing the device to determine which of the character codes is appropriate for handling received data representing the character information, for displaying characters represented by the character information; and
automatically placing the device in an operating mode which enables use of the appropriate character code.

In accordance with a still further aspect of the invention, there is provided a communications device operable to receive and enable display of character information which has been processed according to the method described above, comprising:
means operable to determine which of the character codes is appropriate for handling received data representing the character information, for displaying characters represented by the character information; and
means operable to automatically place the device in an operating mode which enables use of the appropriate character code.

In accordance with a still further aspect of the invention, there is provided a method of operating a communications device operable to electronically process data for representing characters of a text message, at least some or all of the characters being definable using a plurality of character codes which require respective computer memory units of mutually different sizes to respectively store sufficient data to represent a single character, the method comprising:
causing the device to receive text character information relating to desired characters input by a user;
causing the device to encode the character information for transmission over a network and to store the data representing the character information in a computer memory of the device; and
causing the device to portion the data into a plurality of data portions such that each portion respectively occupies less memory than a threshold amount below which short message transmission is permitted by a desired short message communication service; characterised in that
the data in each respective said data portion is encoded according to a respective said character code which, whilst enabling representation of every character disposed in the respective data portion, requires the smallest unit of computer memory per character.

This facilitates a reduction in the number of data portions which have to be sent through the communication service to transmit a text message which is larger than the threshold amount, since message portions which do not require a more complex character code utilise a less memory intensive, less complex character code.

Preferably, the data is portioned so as to maximise the total number of characters represented in the or each data portion which is encoded according to said character code requiring the smallest unit of computer memory per character.

This facilitates a further reduction in the number of data portions which have to be sent through the communication service to transmit a text message which is larger than the threshold amount.

Preferably, the device is caused to display the received text character information on a display apparatus as a contiguous message. This facilitates correct input of the text character by a user.

The device may be caused to display on the display apparatus a visual indication corresponding to the boundary between each portion of the data. This facilitates alerting a user to the number of short messages which will be used to send the text message.

In accordance with a further aspect of the invention, there is provided a communications device for electronically processing data for representing characters of a text message, at least some of the characters being definable using a plurality of character codes which require respective computer memory units of mutually different sizes to respectively store sufficient data to represent a single character, the device comprising:
memory means operable to receive and store text character information relating to desired characters input by a user;
encoding means operable to encode the character information as data for transmission over a network and to store the data in a computer memory of the device; and
portioning means operable to portion the data into a plurality of data portions such that each portion respectively occupies less memory than a threshold amount below which short message transmission is permitted by a desired short message communication service;
the encoding means being operable to encode the data in each respective said data portion according to a respective said character code which, whilst enabling representation of every character disposed in the respective data portion, requires the smallest unit of computer memory per character.

In accordance with a still further aspect of the invention, there is provided a method of operating a communications device so as to receive and enable display of character information transmitted to the device as a plurality of data portions in accordance with the method described above, comprising:
causing the device to determine which of the respective character codes is appropriate for handling data received in each of the respective data portions; and
causing the device to automatically place the device in an operating mode which enables use of the appropriate character code for handling each respective data portion for causing the character information to be displayed.

Preferably, the method further comprises concatenating the data portions for causing display of the character information as a contiguous message.

In accordance with a still further aspect of the invention, there is provided a communications device operable to receive and enable display of character information transmitted to the device as a plurality of data portions in accordance with the method described above, the device comprising:
determining means operable to determine which of the respective character codes is appropriate for handling data received in each of the respective data portions; and
means operable to automatically place the device in an operating mode which enables use of the appropriate character code for handling each respective data portion for causing the character information to be displayed.

In accordance with a still further aspect of the invention, there is provided a computer program comprising computer executable instructions for causing a computer to perform any one of the methods described above in accordance with the invention.

In accordance with a still further aspect of the invention, there is provided a carrier having stored thereon the computer program described in the last preceding paragraph.

The carrier can be any entity or device capable of carrying the computer program and may, for example comprise: a storage medium such as ROM, for example a CD ROM or semiconductor ROM; a magnetic recording medium, for example a floppy disc or hard disc; a transmissible electrical or optical signal conveyable for example by electrical or optical cable or over the air, for example by radio; a cable or other means for directly carrying the program as a signal; or an integrated circuit in which the program is embedded.

In accordance with a still further aspect of the invention, there is provided a communications device, for example a hand portable device such as a wireless telephone or PDA, comprising ROM in which the computer program is stored.

The invention facilitates providing a user with the impression that there is no size restriction on text messages for sending through a short message service. Embodiments also provide the advantage of reducing the number of message portions required to be sent for longer messages.

The invention can be employed to particular advantage in relation to handheld wireless communications-devices such as mobile cellular telephones and, in order that the invention may be well understood, an embodiment thereof will now be described, by way of example only, with reference to a mobile cellular telephone device. However it will be apparent that any text-enabled telecommunications device could be used to implement the invention.

An embodiment of the invention will be described with reference to the accompanying drawings in which:

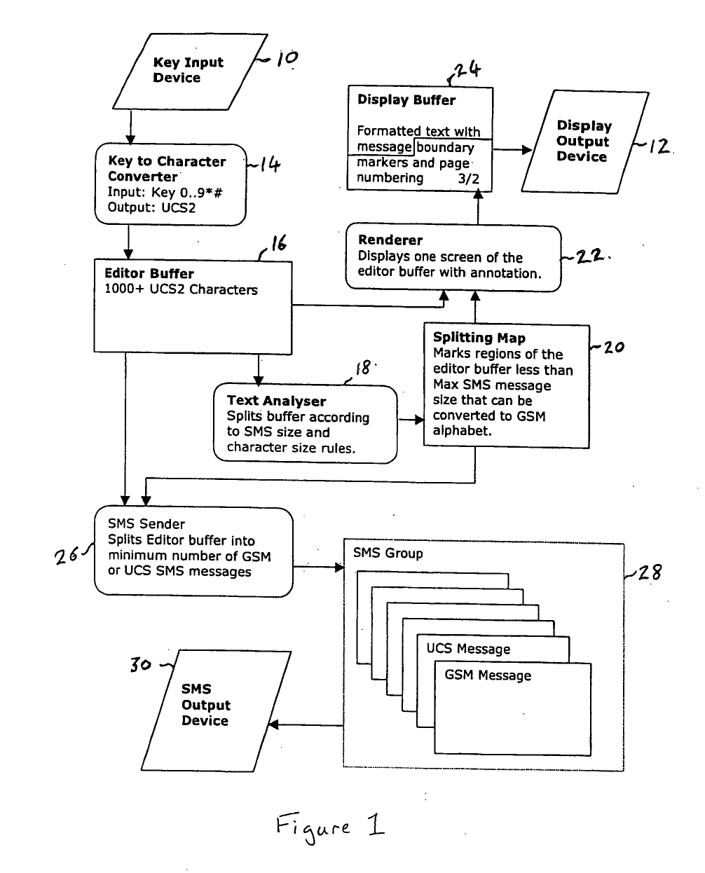

FIG. 1 is a data flow diagram for creating and sending a text message using a device in accordance with the embodiment; and

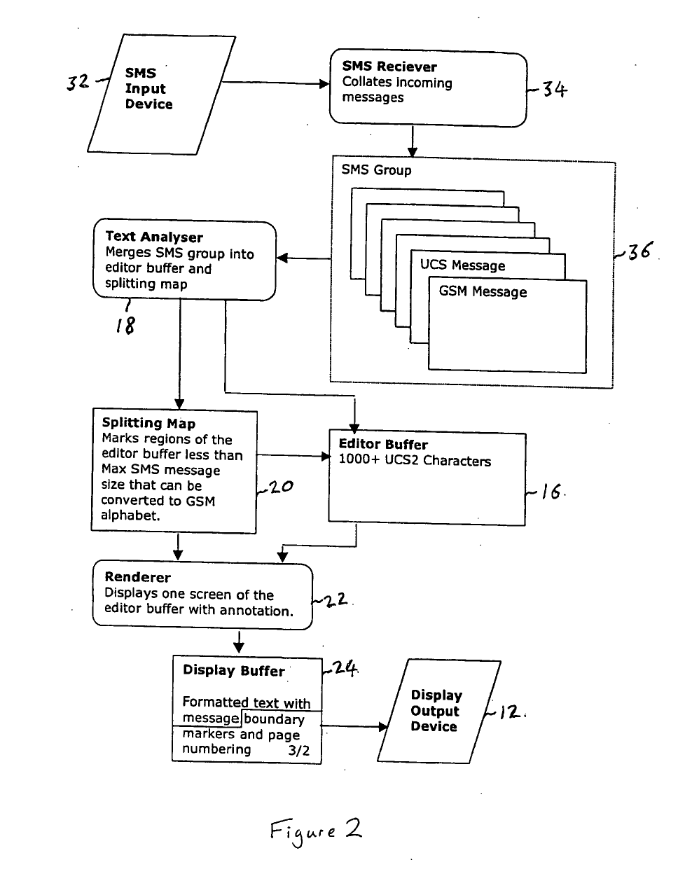

FIG. 2 is a data flow diagram for receiving and displaying a text message using the device in accordance with the embodiment.

As noted above, message communication services generally specify a threshold, limiting the size of message (ie the amount of data) which can be transmitted in a single transmission. For example, a short message in SMS format, as presently employed in message communication services using the GSM wireless communications system, commonly contains data encoded using a 7-bit GSM Alphabet code, as specified in ETSI Specification 900_E3, that requires 7 bits of computer memory to store sufficient data to represent a single character. Due to the predetermined limit to the amount of data which is transmissible per short message transmission, the number of characters per short message is limited to 160. The character set in GSM 7-bit code is limited to 127, generally alphanumeric, characters. However, in some circumstances a greater selection of characters is required.

In response to this need, a communications device in the form of a mobile cellular telephone device in accordance with the embodiment provides its user with an option of encoding data using a more complex character code, for representing more complex characters. An example of a more complex type of character code is Unicode, specifically USC 2 (USC=Universal Coding Scheme), which enables representation of a larger character set (up to 65,536 characters), including Russian and Chinese characters, pictures and symbols. However, Unicode requires two bytes (16 bits) of computer memory per character, and the number of characters per SMS short message is correspondingly reduced to 70.

The device comprises a central processor unit (CPU), random access memory (RAM), and carries character code data stored in ROM which can be selectively accessed through the CPU for enabling encoding of character information input by the user into text data for transmission across a network. The character code data includes information relating at least to the Unicode character set, for handling complex characters, and also to the GSM 7-bit character set, for handling less complex characters using less memory per character. The device also includes a text editor for enabling a user to edit text.

Referring to FIG. 1, the flow of data for creating and sending a text message commences at a key input device 10 of a user interface. The user interface further includes and a visual display output device 12. An encoding means in the form of a key to character converter 14 transforms user-selected character information into digital data in accordance with formatting information contained in the character code data. When a user inputs a text message consisting of characters selected through the user interface input device 10, the user interface outputs the information in the form of an electrical signal to the encoding means 14, which then digitally encodes the character information using the character code data. The resulting data is stored in an editor buffer memory 16. The data currently in the buffer is also used to display on the display output device 12 the characters selected by the user.

The encoding means 14 compares the user-selected character information with the character code data and determines to which of the character sets the respective user-selected characters belong. The default mode is USC 2. The GSM 7 encoding is a subset and each character is determined to be present in the subset by searching a table giving the USC 2 values for the GSM codes. This information is used by the encoding means to determine which of the character codes (Unicode or 7-bit GSM) to use to effect encoding.

The device uses the determined information to automatically select the most appropriate character code, in other words the character code which on the one hand is capable of representing all of the characters in the message and on the other hand also requires the smallest memory unit per character. Thus, the device operates in an operating mode wherein the encoding means 14 accesses memory addresses where the character code data relating to the most appropriate character code is stored. The character information is encoded and stored in the editor buffer memory 16. The buffer memory is large enough, for example, to contain information for representing up to 1000 GSM characters (500 bytes), and in any event is not limited to the threshold size for transmitting a single message.

A message portioning means in the form of a text analyser 18 and a splitting map 20 divides the message into portions which respectively occupy an area of memory which is less than a predetermined threshold amount transmissible by a network through which it is desired to transmit the message. If, for example, Chinese characters appear in the message, Unicode is automatically selected for encoding the message. If the memory available for SMS transmission is, say, 160 bytes, 70 Unicode characters (at two bytes per character) or less will be represented in each message portion. It should be noted that some of the available memory will probably be required for purposes other than character representation, for example identifying the position of a message portion in the message.

The splitting map 20 of the portioning means enters in the memory relating to each portion marking data for marking the beginning and the end of adjacent message portions. The splitting map 20 marks regions of the editor buffer 16 having less than the maximum SMS message size that can be converted to GSM characters. This data is read by a renderer 22 which compiles the data into one or more individual screens of displayable information, which are stored in a display buffer 24. The screens are then viewable by the user one at a time on the display output device 12.

The portioning means enables the device to recognise what data should be transmitted in each portion, and to create a dividing mark between message portions on the visual display. Thus, whilst the display buffer 24 enables the device to display the message portions as a contiguous longer message, viewing the display output device 12 enables a user to recognise how many short message transmissions will be necessary to transmit the longer message. The device may indicate on the display output device 12 how many portions are presently contained in the message. Also, portion data can be automatically generated and added to each message portion, the portioning means leaving three character spaces at the end of each message portion for receiving and storing this portion data. This data relates to header information regarding the total number of a sequence of portions constituting a message and the number of the present portion in the sequence, for example ⅓, ⅔. This will be useful if a device receiving the message is not configured to automatically concatenate the portions in the correct sequence.

In a modified embodiment, the device is caused to automatically reduce the number of portions required to send a longer message. Thus, the operating mode is selected separately for each message portion to enable appropriate encoding of each portion according to the character code necessary to encode all of the characters therein.

In a further modification, a further reduction in the number of data portions required is achieved by applying “smart splitting” to a long message comprising a mixture of GSM and Unicode characters. In this method, the message is divided so as to maximise the number of characters contained in portions which can be encoded using GSM characters. For example, consider a message in which the first 100 characters are GSM compatible, then the user enters some Chinese text. Rather than convert the entire message to Unicode and split at around 70 characters, leaving about 40 Unicode characters available in the second portion, GSM character code is used for encoding the first portion and the split is made at 100. This leaves space for about 70 Unicode characters in the second portion.

Once the user has entered the message, and decides to send it, an instruction is entered on the key input device 10 and an SMS sender reads the data in the editor buffer 16, together with the portioning data from the portioning means (18, 20) and splits the message into the determined number of GSM, or UCS SMS messages to compile a SMS group 28 of messages, which are transmitted sequentially by an SMS output device 30 over the network.

Referring to FIG. 2, in which the same components have the same reference numerals as FIG. 1, the flow of data for receiving and displaying a text message comprising one or more SMS messages commences at an SMS input device 32, operable for receiving SMS messages over the network. The input device converts the received signal into an electrical signal and passes it to an SMS receiver 34, which collates the incoming messages into an SMS group 36.

The text analyser 18 of the portioning means merges the SMS group into a single message which is stored in the editor buffer 16. However, the splitting map 20 of the portioning means marks the regions of the editor buffer in the same way as it does for a message created by the user, as described above. The data from the editor buffer 16 and splitting map 20 is used by the renderer 20 to generate the display data for storage in the display buffer 24 and display on the display output device 12, in the same way as described above for displaying a message created by the user.

It will be appreciated that the text editor, coding means, and portioning means can be implemented in many ways. Whilst the exemplary devices are implemented by a computer program stored on a carrier in the form of EPROM. This is a preferred implementation for a handset, but the concept also applies to a PC or PDA tool editor and SMS sender that would operate in the same fashion. These would place the program code in RAM. This should in no way be construed as limiting the invention to this implementation.

1. A method of operating a communications device operable to electronically process data for representing characters of a text message, at least some or all of the characters being definable using a plurality of character codes which require respective computer memory units of mutually different sizes to respectively store sufficient data to represent a single character, the method comprising:
causing the device to receive text character information relating to desired characters input by a user;
causing the device to determine which of the character codes is appropriate for representing the desired characters; and
placing the device in an operating mode which enables use of the appropriate character code which requires the smallest computer memory unit per character for storing the encoded character information for transmission over a network.

2. A communications device operable to electronically process data for representing characters of a text message, at least some or all of the characters being encodable as data using a plurality of character codes which require respective computer memory units of mutually different sizes to respectively store sufficient data to represent a single character, the device comprising:
memory means operable to receive and store text character information relating to desired characters input by a user;
determining means operable to determine which of the character codes is appropriate for representing the desired characters; and
means operable to place the device in an operating mode which enables use of the appropriate character code which requires the smallest computer memory unit per character for storing the encoded character information for transmission over a network.

3. A method of operating a communications device so as to receive and enable display of character information which has been processed according to the method of claim 1, comprising:
causing the device to determine which of the character codes is appropriate for handling received data representing the character information, for displaying characters represented by the character information; and
placing the device in an operating mode which enables use of the appropriate character code.

4. A communications device operable to receive and enable display of character information which has been processed according to the method of claim 1, comprising:
means operable to determine which of the character codes is appropriate for handling received data representing the character information, for displaying characters represented by the character information; and
means operable to place the device in an operating mode which enables use of the appropriate character code.

5. A method of operating a communications device operable to electronically process data for representing characters of a test message at least some or all of the characters being definable using a plurality of character codes which require respective computer memory units of mutually different sizes to respectively store sufficient data to represent a single character, the method comprising:
causing the device to receive text character information relating to desired characters input by a user;
causing the device to encode the character information for transmission over a network and to store the data representing the character information in a computer memory of the device; and
causing the device to portion the data into a plurality of data portions such that each portion respectively occupies less memory than a threshold amount below which short message transmission is permitted by a desired short message communication service; characterised in that the data in each respective said data portion is encoded according to a respective said character code which, whilst enabling representation of every character disposed in the respective data portion, requires the smallest unit of computer memory per character.

6. A method of operating a communications device according to any one of claims 1, 3, or 5 wherein the data is portioned so as to maximise the total number of characters represented in the or each data portion which is encoded according to said character code requiring the smallest unit of computer memory per character.

7. A communications device according to claim 2 or claim 4, comprising means for portioning the data so as to maximise the total number of characters represented in the or each data portion which is encoded according to said character code requiring the smallest unit of computer memory per character.

8. A method according to any one of claims 2, 3, 5 or 6 comprising causing to display the received text character information on a display apparatus as a contiguous message.

9. A communications device according to any one of claims 2, 4 or 7 comprising means for causing display of the received text character information on a display apparatus as a contiguous message.

10. A communications device for electronically processing data for representing characters of a text message, at least some of the characters being definable using a plurality of character codes which require respective computer memory units of mutually different sizes to respectively store sufficient data to represent a single character, the device comprising:
memory means operable to receive and store text character information relating to desired characters input by a user;
encoding means operable to encode the character information as data for transmission over a network and to store the data in a computer memory of the device; and portioning means operable to portion the data into a plurality of data portions such that each portion respectively occupies less memory than a threshold amount below which short message transmission is permitted by a desired short message communication service;
the encoding means being operable to encode the data in each respective said data portion according to a respective said character code which, whilst enabling representation of every character disposed in the respective data portion, requires the smallest unit of computer memory per character.

11. A method of operating a communications device so as to receive and enable display of character information transmitted to the device as a plurality of data portions in accordance with the method of claim 5, comprising:
causing the device to determine which of the respective character codes is appropriate for handling data received in each of the respective data portions; and
causing the device to place the device in an operating mode which enables use of the appropriate character code for handling each respective data portion for causing the character information to be displayed.

12. A method according to claim 11 further comprising concatenating the data portions for causing display of the character information as a contiguous message.

13. A communications device operable to receive and enable display of character information transmitted to the device as a plurality of data portions in accordance with the method of claim 5, the device comprising:
determining means operable to determine which of the respective character codes is appropriate for handling data received in each of the respective data portions; and
means operable to place the device in an operating mode which enables use of the appropriate character code for handling each respective data portion for causing the character information to be displayed.

14. A computer program comprising computer executable instructions for causing a computer to perform any one of the methods described in claims 1, 3, 5, 6, 8, 11 and 12.

15. A carrier having stored thereon a computer program as defined in claim 14.

16. A communications device comprising ROM in which the computer program as defined in claim 14 is stored.

17. A hand portable wireless telephone comprising the communications device in accordance with any one of claims 2, 4, 8 or 12.
